(19) United States
(12) Patent Application Publication
(10) Pub. No.: US 2017/0203210 A1
(43) Pub. Date: Jul. 20, 2017

(54) ENABLING APPLICATION DELIVERY IN PROMOTIONAL AND OTHER CONTEXTS

(71) Applicant: TreSensa Inc., New York, NY (US)

(72) Inventors: Oliver Marsh, Zagreb (HR); Benjamin Swiss, New York, NY (US); Charles Parra, New York, NY (US)

(21) Appl. No.: 15/406,166

(22) Filed: Jan. 13, 2017

Related U.S. Application Data
(60) Provisional application No. 62/278,880, filed on Jan. 14, 2016.

(51) Int. Cl. A63F 13/352; A63F 13/537; A63F 13/61; H04M 1/725; H04W 4/00

(52) U.S. Cl. CPC A63F 13/352; H04M 1/72525; H04W 4/003; H04W 4/001; H04M 1/72544; A63F 13/61; A63F 13/537

(57) ABSTRACT

Systems and methods are disclosed for enabling application delivery. In one implementation, a processing device receives a first application including a plurality of functionalities, processes the first application to generate a playable application comprising a subset of the plurality of functionalities, and provides the playable application to a user device, where the user device is to display the playable application in conjunction with a second application that is installed on the user device, and the user device is to receive user interaction of a user with the playable application. In another implementation, a processing device receives a freestanding application via an application distribution system, executes the freestanding application on the user device, receives a playable application not via the application distribution system, where the playable application is not freestanding, displays the playable application in conjunction with the freestanding application, and receives user interaction of a user with the playable application.

### CROSS-REFERENCE TO RELATED APPLICATION

This application is related to and claims the benefit of U.S. Patent Application No. 62/278,880, filed Jan. 14, 2016, the entirety of which is incorporated herein by reference.

### TECHNICAL FIELD

Aspects and implementations of the present disclosure relate to data processing, and more specifically, to enabling application delivery in promotional and other contexts.

### BACKGROUND

Applications (e.g., a mobile application or ‘app,’ such as a game) may be developed for execution in a ‘freestanding’ capacity (i.e., in a manner which provides substantially all of the various capabilities of the application). The applications may need to be obtained (e.g., downloaded) from an application distribution service (e.g., an ‘app store’ which provides applications to various devices).

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

In an aspect of the present disclosure, a processing device receives a first application including a plurality of functionalities. The processing device processes the first application to generate a playable application including a subset of the plurality of functionalities. The processing device provides the playable application to a user device, where the user device is to display the playable application in conjunction with a second application that is installed on the user device, and the user device is to receive user interaction of a user with the playable application.

In another aspect of the present disclosure, a processing device receives a freestanding application via an application distribution system. The processing device receives a playable application, where the playable application is not freestanding and is not received via the application distribution system. The processing device executes the freestanding application on the user device. The processing device displays the playable application in conjunction with the freestanding application. The processing device receives user interaction of a user with the playable application.

In another aspect of the present disclosure, a processing device receives a first application including a plurality of functionalities. The processing device processes the first application to generate a playable application including a subset of the plurality of functionalities, the playable application including an application configured for presentation in conjunction with a second application. The processing device receives one or more inputs with respect to the second application from a user device with respect to which the second application can be determined to be installed. The processing device provides the playable application to the user device in response to receipt of the one or more inputs, where the user device is to display the playable application in conjunction with the second application and the user device is to receive user interaction of a user with the playable application.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 depicts an illustrative system architecture, in accordance with one implementation of the present disclosure.

FIG. 2 depicts a user device, in accordance with one implementation of the present disclosure.

FIG. 3A depicts a flow diagram of aspects of a method for enabling application delivery, in accordance with one implementation of the present disclosure.

FIG. 3B depicts a flow diagram of aspects of a method for receiving a playable application at a user device, in accordance with one implementation of the present disclosure.

FIG. 3C depicts a flow diagram of aspects of a method for enabling application delivery, in accordance with one implementation of the present disclosure.

FIG. 4A is an example graphical user interface (GUI) of an exemplary playable application, in accordance with aspects and implementations of the present disclosure.

FIG. 4B is an example GUI of interaction with an exemplary playable application, in accordance with aspects and implementations of the present disclosure.

FIG. 4C is an example GUI of a prompt to take further action, in accordance with aspects and implementations of the present disclosure.

FIG. 5A is an example GUI for presenting a playable application, in accordance with aspects and implementations of the present disclosure.

FIG. 5B is an example GUI displaying an interface control to obtain a full version of the application, in accordance with aspects and implementations of the present disclosure.

FIG. 5C is an example GUI for obtaining a full version of the application, in accordance with aspects and implementations of the present disclosure.

FIG. 6 depicts a block diagram of an illustrative computer system operating in accordance with aspects and implementations of the present disclosure.

### DETAILED DESCRIPTION

Aspects and implementations of the present disclosure are directed to enabling application delivery in promotional and other contexts. The systems and methods disclosed can be applied to digital media content such as applications, games, etc., such as those that can be provided and/or deployed within various contexts such as on mobile computing devices, laptop/desktop computers, incorporated/embedded within websites, etc.

Promotional content may be static promotional content such as an image or text. Promotional content may be media content (e.g., video, audio, images, text, etc.) that plays (e.g., plays once, automatically plays over and over again (loops), etc.). These forms of promotional content do not allow for user interaction and are limited in effectiveness to promote or convey advantages and features of a service or product (e.g., an application, a website, a company, etc.).

A user may interact with an application (e.g., a mobile application or app, such as a game). An application (e.g., a mobile application or ‘app,’ such as a game) may be initially developed for execution in a ‘freestanding’ capacity (e.g., in a manner which provides substantially all of the various capabilities of the application, execution does not require execution of the application in conjunction with another application). In certain implementations, such applications may need to be obtained (e.g., downloaded) from an application distribution service (e.g., an ‘app store’ which provides applications to various devices). The additional technical operations that such an installation entails (e.g., affirmatively requesting the application from the ‘app store,’ waiting for it to download and install, configuring it, etc.) may dissuade users from initially trying or sampling the application (for example, various downloadable games may be graphic-intensive and thus require the downloading of large amounts of data before being playable). Such a scenario is sub-optimal both for users who may wish to ‘sample’ an application or game before downloading it, as well as for entities (e.g., application developers, application distribution services, an entity that provides interactive promotional content) who may be limited in the manner in which they can effectively promote and/or convey the advantages and/or features of their service, product, application(s), etc. (e.g., if relying only on static promotional content, e.g., images, videos, etc.).

Accordingly, as described in detail herein, the disclosed technologies enable providing a playable application (e.g., the conversion of an application (e.g., a mobile application, game, etc.)) in a format that can be distributed to various users (e.g., mobile devices) such that the playable application, as formatted (e.g., converted from a freestanding application, converted from an application available for download from an application distribution service, etc.), can be provided to and/or presented at a user device in a relatively efficient capacity. In doing so, the playable application can be presented in various contexts (e.g., in a promotional context) that enable a user to interact with the playable application and/or sample the functionality of the full application (e.g., from which the playable application is converted). Such a playable application (which can be interacted with by the user in the same or similar manner as an original application itself) can provide an entity (e.g., a developer) with a far more effective way to promote their service or product (e.g., applications) than static promotional content. It should be understood that, in certain implementations, the playable application may be in a language such as HTML5, Flash®, etc., which enables the playable application to be efficiently provided to the user device and also enables interaction with the playable application at the device.

At this juncture it should be understood that various implementations of the disclosed technologies provide numerous advantages and improvements upon conventional approaches. By way of example, while existing technologies may enable the delivery of static content to a user on behalf of a developer (e.g., static images/videos of promotional content, static image/videos that relate to a freestanding application from an application distribution service, etc.), such technologies do not enable a user to actively interact with a playable application and/or ‘sample’ the functionality of the freestanding application. In contrast, the technologies described herein enable providing of a playable application (e.g., the conversion of a freestanding application) in a format that can be efficiently delivered to a user device and subsequently interacted with at the user device (e.g., within the context of another application, such as in between levels of a game). In doing so, in one implementation, the user can sample the functionality of the ‘full’ application via the playable application (e.g., converted application) and can take further action (e.g., to download the ‘full’ application) as a result.

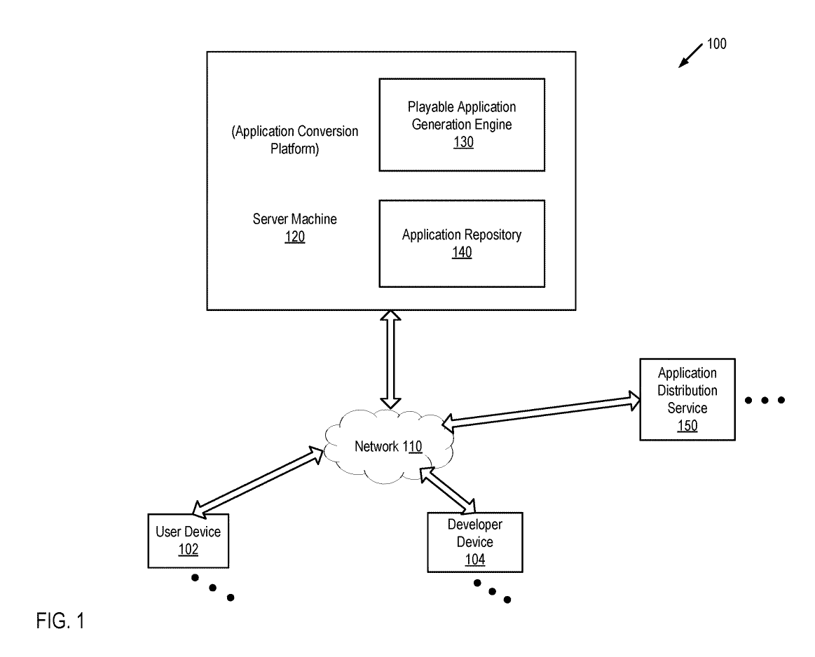

FIG. 1 depicts an illustrative system architecture 100, in accordance with one implementation of the present disclosure. The system architecture 100 includes one or more user devices 102, developer devices 104, server machine 120, and application distribution service 150 (e.g., application distribution system 150). These various elements or components can be connected to one another via network 110, which can be a public network (e.g., the Internet), a private network (e.g., a local area network (LAN) or wide area network (WAN)), or a combination thereof. Additionally, in certain implementations various elements may communicate and/or otherwise interface directly with one another.

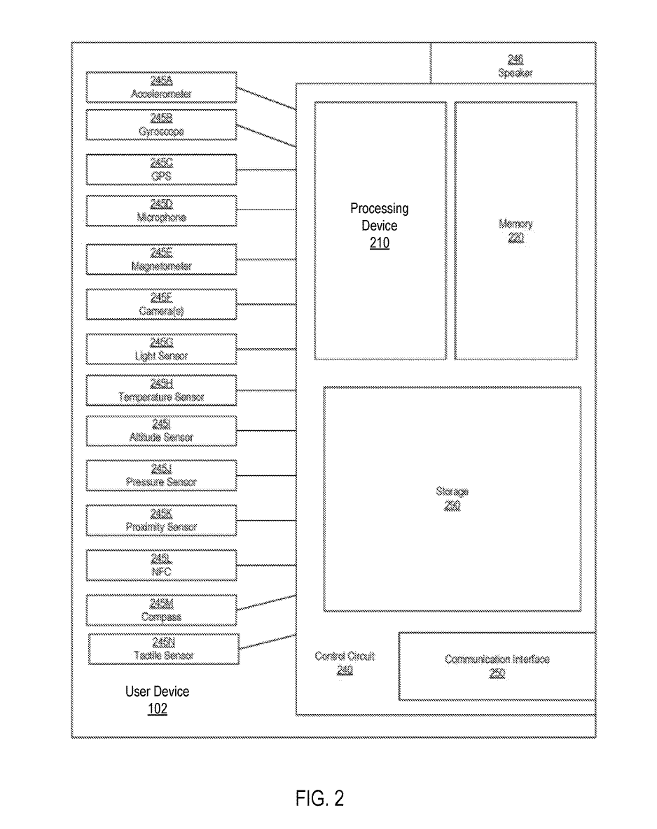

User device 102 can be a rackmount server, a router computer, a personal computer, a portable digital assistant, a mobile phone, a laptop computer, a tablet computer, a camera, a video camera, a netbook, a desktop computer, a media center, a smartphone, a watch, a smartwatch, an in-vehicle computer/system, any combination of the above, or any other such computing device capable of implementing the various features described herein. Various applications, such as mobile applications (‘apps’) (e.g., those received from application distribution service 150), web browsers, desktop applications, etc. (not shown) may run on the user device (e.g., on the operating system of the user device). It should be understood that, in certain implementations, user device 102 can also include and/or incorporate various sensors and/or communications interfaces (including but not limited to those depicted in FIG. 2 and/or described herein). Examples of such sensors include but are not limited to: accelerometer, gyroscope, compass, GPS, haptic sensors (e.g., touchscreen, buttons, etc.), microphone, camera, etc. Examples of such communication interfaces include but are not limited to cellular (e.g., 3G, 4G, etc.) interface(s), an interface that uses Bluetooth® technology, an interface that uses WiFi™ technology, an interface that uses the universal serial bus (USB) standard, an interface that uses near-field communication (NFC) technology, etc.

FIG. 2 depicts a user device 102, in accordance with one implementation of the present disclosure. User device 102 in FIG. 2 may be the same as user device 102 in FIG. 1. As noted, in certain implementations, user device(s) 102 can also include and/or incorporate various sensors and/or communications interfaces. As shown in FIG. 2, device 102 can include a control circuit 240 (e.g., a motherboard) which is operatively connected to various hardware and/or software components that serve to enable various operations, such as those described herein. Control circuit 240 can be operatively connected to processing device 210 (e.g., processor 210) and memory 220. Processing device 210 serves to execute instructions for software that can be loaded into memory 220. Processing device 210 can be a number of processing devices, a multi-processor core, or some other type of processing device, depending on the particular implementation. Further, processing device 210 can be implemented using a number of heterogeneous processing device systems in which a main processing device is present with secondary processing devices on a single chip. As another illustrative example, processing device 210 can be a symmetric multi-processing device system containing multiple processing devices of the same type.

Memory 220 and/or storage 290 may be accessible by processing device 210, thereby enabling processing device 210 to receive and execute instructions stored on memory 220 and/or on storage 290. Memory 220 can be, for example, a random access memory (RAM) or any other suitable volatile or non-volatile computer readable storage medium (e.g., non-transitory computer readable medium). In addition, memory 220 can be fixed or removable. Storage 290 can take various forms, depending on the particular implementation. For example, storage 290 can contain one or more components or devices. For example, storage 290 can be a hard drive, a flash memory, a rewritable optical disk, a rewritable magnetic tape, or some combination of the above. Storage 290 also can be fixed or removable.

A communication interface 250 is also operatively connected to control circuit 240. Communication interface 250 can be any interface (or multiple interfaces) that enables communication between user device 102 and one or more external devices, machines, services, systems, and/or elements (including but not limited to those depicted in FIG. 1 and described herein). Communication interface 250 can include (but is not limited to) a modem, a Network Interface Card (NIC), an integrated network interface, a radio frequency transmitter/receiver (e.g., WiFi™, Bluetooth®, cellular, NFC), a satellite communication transmitter/receiver, an infrared port, a USB connection, or any other such interfaces for connecting device 102 to other computing devices, systems, services, and/or communication networks such as the Internet. Such connections can include a wired connection or a wireless connection (e.g., 802.11) though it should be understood that communication interface 250 can be practically any interface that enables communication to/from the control circuit 240 and/or the various components described herein.

At various points during the operation of described technologies, device 102 can communicate with one or more other devices, systems, services, servers, etc., such as those depicted in FIG. 1 and/or described herein. Such devices, systems, services, servers, etc., can transmit and/or receive data to/from the user device 102, thereby enhancing the operation of the described technologies, such as is described in detail herein. It should be understood that the referenced devices, systems, services, servers, etc., can be in direct communication with user device 102, indirect communication with user device 102, constant/ongoing communication with user device 102, periodic communication with user device 102, and/or can be communicatively coordinated with user device 102, as described herein.

Also connected to and/or in communication with control circuit 240 of user device 102 are one or more sensors 245A-245N (collectively, sensors 245). Sensors 245 can be various components, devices, and/or receivers that can be incorporated and/or integrated within and/or in communication with user device 102. Sensors 245 can be configured to detect one or more stimuli, phenomena, or any other such inputs, described herein. Examples of such sensors 245 include, but are not limited to, an accelerometer 245A, a gyroscope 245B, a global positioning system (GPS) receiver 245C, a microphone 245D, a magnetometer 245E, camera(s) 245F, a light sensor 245G, a temperature sensor 245H, an altitude sensor 245I, a pressure sensor 245J, a proximity sensor 245K, an NFC device 245L, a compass 245M, and a tactile sensor 245N. As described herein, device 102 can perceive/receive various inputs from sensors 245 and such inputs can be used to initiate, enable, and/or enhance various operations and/or aspects thereof, such as is described herein.

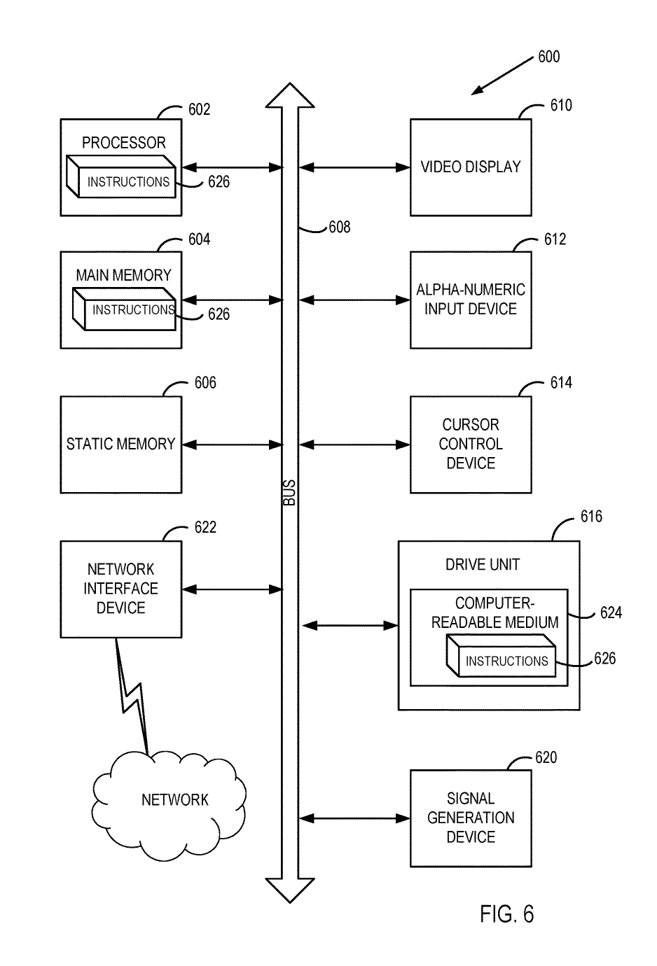

At this juncture it should be noted that while the foregoing description (e.g., with respect to sensors 245) has been directed to user device 102, various other devices, systems, servers, services, etc. (such as are depicted in FIG. 1 and/or described herein) can similarly incorporate the components, elements, and/or capabilities described with respect to user device 102. For example, developer device 104 may also incorporate one or more of the referenced components, elements, and/or capabilities. It should also be understood that certain aspects and implementations of various devices, systems, servers, services, etc., such as those depicted in FIG. 1 and/or described herein, are also described in greater detail below in relation to FIG. 6.

Returning to FIG. 1, developer device 104 can be a rackmount server, a router computer, a personal computer, a portable digital assistant, a mobile phone, a laptop computer, a tablet computer, a camera, a video camera, a netbook, a desktop computer, a media center, a smartphone, a watch, a smartwatch, an in-vehicle computer/system, any combination of the above, or any other such computing device capable of implementing the various features described herein. Various applications, such as mobile applications (‘apps’), web browsers, etc. (not shown) may run on the developer device (e.g., on the operating system of the developer device). Moreover, in certain implementations such applications can be developed, modified, etc., at developer device 104 and provided to application distribution service 150 (such that they can be distributed to other devices such as user devices 102). It should be understood that, in certain implementations, developer device 104 can also include and/or incorporate various sensors and/or communications interfaces (not shown). Examples of such sensors include but are not limited to: accelerometer, gyroscope, compass, GPS, haptic sensors (e.g., touchscreen, buttons, etc.), microphone, camera, barcode scanner, etc. Examples of such communication interfaces include but are not limited to cellular (e.g., 3G, 4G, etc.) interface(s), Bluetooth® interface, WiFi™ interface, USB interface, NFC interface, etc. It should be understood that, in certain implementations, developer device 104 can also include and/or incorporate various sensors and/or communications interfaces (including but not limited to those depicted in FIG. 2 and described in relation to user device 102).

Server machine 120 can be a rackmount server, a router computer, a personal computer, a portable digital assistant, a mobile phone, a laptop computer, a tablet computer, a camera, a video camera, a netbook, a desktop computer, a smartphone, any combination of the above, or any other such computing device capable of implementing the various features described herein. Server machine 120 can include components such as playable application generation engine 130, and application repository 140. The components can be combined together or separated in further components, according to a particular implementation. It should be noted that in some implementations, various components of server machine 120 may run on separate machines (for example, application repository 140 can be a separate device). Moreover, some operations of certain of the components are described in more detail below. It should be understood that, in certain implementations, server machine 120 can also include and/or incorporate various sensors and/or communications interfaces (including but not limited to those depicted in FIG. 2 and described in relation to user device 102).

Playable application generation engine 130 may include one or more processing devices, one or more processing logic, a combination of one or more processing devices and one or more processing logic, etc. In one implementation, playable application generation engine 130 receives a freestanding application from application distribution service 150 and generates a playable application from the freestanding application. In another implementation, the playable application generation engine 130 generates a playable application not based on a freestanding application. In another implementation, the playable application generation engine 130 receives one or more portions of the playable application and generates the playable application from the one or more portions of the playable application. In another implementation, the playable application generation engine 130 generates the playable application in conjunction with other processing devices and processing logic (e.g., playable application generation engine 130 performs a portion of the generating of the playable application).

Application repository 140 can be hosted by one or more storage devices, such as main memory, magnetic or optical storage based disks, tapes or hard drives, network-attached storage (NAS), storage area network (SAN), and so forth. In some implementations, application repository 140 can be a network-attached file server, while in other implementations application repository 140 can be some other type of persistent storage such as an object-oriented database, a relational database, and so forth, that may be hosted by the server machine 120 or one or more different machines coupled to the server machine 120 via the network 110, while in yet other implementations application repository 140 may be a database that is hosted by another entity and made accessible to server machine 120. In one implementation, application repository 140 can store applications (e.g., mobile applications or ‘apps,’ games, freestanding applications, applications to be downloaded via an application distribution service, etc.) that can be processed by and/or in conjunction with playable application generation engine 130 to generate playable applications (e.g., convert and/or format such applications into playable applications) that can be delivered/provided to user device(s) 102 such that a user can interact with such playable applications (e.g., in a promotional context, such as within/in conjunction with another application executing on the user device, such as is described herein).

Application distribution service(s) 150 (e.g., application distribution system(s) 150) can be a rackmount server, a router computer, a personal computer, a portable digital assistant, a mobile phone, a laptop computer, a tablet computer, a camera, a video camera, a netbook, a desktop computer, a smartphone, any combination of the above, or any other such computing device capable of implementing the various features described herein. In certain implementations, application distribution service 150 can maintain a repository of applications (‘apps’), such as those that may be provided by developer device(s) 104, and can provide such applications to user device (s) 102 in response to requests from such device(s). Application distribution service 150 may also coordinate the providing of updates to such applications to users that have previously installed a particular application. It should be understood that various application distribution services may provide applications to different devices (e.g., those utilizing different operation systems, those in different locations, those operating on different networks, etc.).

It should be understood that although FIG. 1 depicts server machine 120, user devices 102, developer devices 104, and service 150 as being discrete components, in various implementations any number of such components (and/or elements/functions thereof) can be combined, such as within a single component/system. For example, in certain implementations user devices 102 and/or developer devices 104 can incorporate features of server machine 120.

As described in detail herein, various technologies are disclosed that enable application delivery in promotional and other contexts. In certain implementations, such technologies can encompass operations performed by and/or in conjunction with playable application generation engine 130.

In certain implementations the described technologies can enable conversion of an application into a format that can be distributed or delivered within various contexts (e.g., in a promotional context, such as an advertisement). That is, it can be appreciated that an application (e.g., a mobile application or ‘app,’ such as a game) may be initially developed for execution in a ‘freestanding’ capacity (i.e., in a manner which provides substantially all of the various capabilities of the application). In certain implementations, such applications may need to be obtained (e.g., downloaded) from an application distribution service (e.g., an ‘app store’ which provides applications to various devices). The additional technical operations that such an installation entails (e.g., affirmatively requesting the application from the ‘app store,’ waiting for it to download and install, configuring it, etc.) may dissuade users from initially trying or sampling the application. Accordingly, as described in detail herein, the disclosed technologies enable the conversion of such an application (e.g., a mobile application, game, etc.) into a format that can be distributed to various users (e.g., mobile devices) such that the playable application (e.g., as formatted, as converted, etc.), can be provided and/or presented in a relatively efficient capacity. In doing so, the formatted/converted application can be presented in various contexts (e.g., in a promotional context) that enable a user to sample the functionality of the full application. It should be understood that, in certain implementations, the formatted/converted application may be in a language such as HTML5, Flash®, etc., which enables the converted application to be efficiently provided to the user device and also enables interaction with the application at the device.

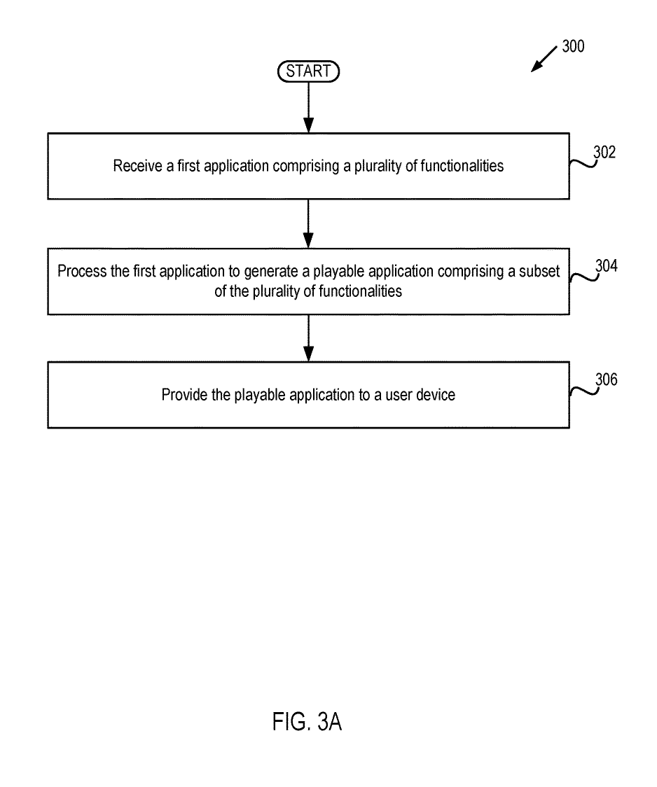

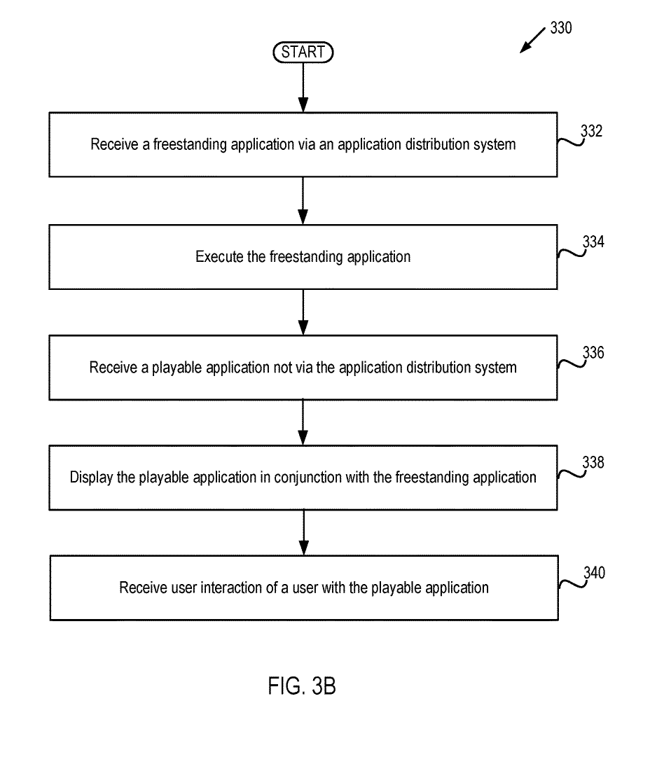

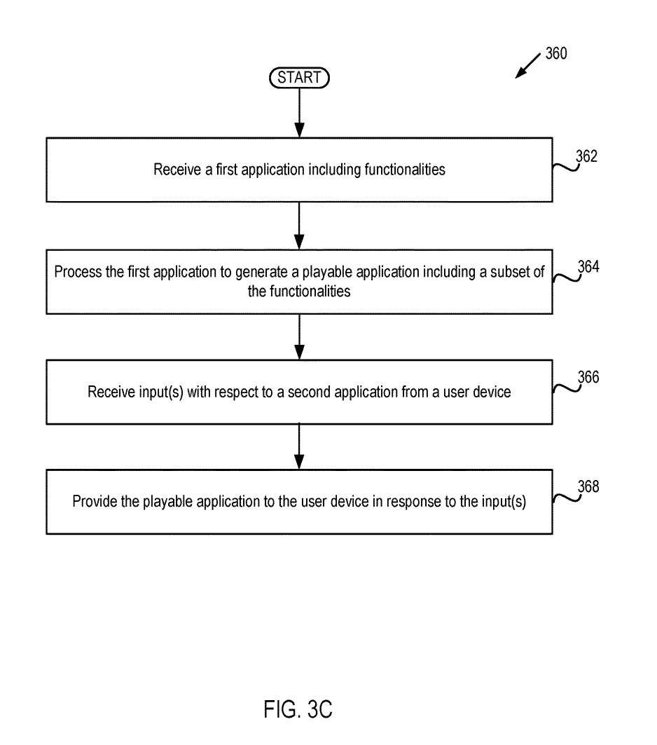

FIGS. 3A-C depict flow diagrams of aspects of methods for enabling application delivery, in accordance with implementations of the present disclosure.

Various aspects of the technologies described herein include one or more methods, such as methods 300, 330, and 360 described herein. The methods 300, 330, and 360 are performed by processing logic that may comprise one or more hardware (one or more processing devices, one or more circuitries, one or more dedicated logic, etc.), one or more software (such as is run on a computing device such as those described herein), or a combination of both. For simplicity of explanation, methods 300, 330, and 360 are described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods 300, 330, and 360 disclosed in this specification are capable of being stored on an article of manufacture to facilitate transporting and transferring such methods to computing devices. The term article of manufacture, as used herein, is intended to encompass a computer program accessible from any computer-readable device or storage media.

FIG. 3A depicts a flow diagram of aspects of a method 300 for enabling application delivery (e.g., in promotional and other contexts), in accordance with one implementation of the present disclosure.

At block 302, processing logic receives a first application comprising a plurality of functionalities. The first application can be received from a developer device and/or from an application distribution service 150. It should be understood that, in certain implementations, various aspects of block 302 can be performed by playable application generation engine 130 and/or server machine 120, while in other implementations such aspects may be performed by one or more other elements/components, such as those described herein. The first application may be a freestanding application (e.g., does not need to be displayed in conjunction with another application).

At block 304, processing logic processes the first application to generate a playable application (e.g., converted application, such as is described herein) comprising a subset of the plurality of functionalities. The playable application can be, for example, an application configured for presentation in conjunction with a second application (e.g., during the execution of the second application, such as in between levels of a game, overlaid on or within a particular region of a webpage, etc., such as in a manner described herein). In certain implementations, various aspects of block 304 can be performed by playable application generation engine 130 and/or server machine 120, while in other implementations such aspects may be performed by one or more other elements and/or components, such as those described herein. In one example, the plurality of functionalities may be a set of levels of a game and the subset of functionalities may be a subset of the set of levels of the game. The first application may be converted to form the playable application. In one implementation, the playable application may not be downloaded from an application distribution service 150. In one implementation, the playable application may not be freestanding (e.g., may need to be displayed in conjunction with another application).

At block 306, processing logic provides the playable application to a user device. The playable application may be provided to the user device in response to receiving one or more inputs with respect to the second application. The inputs can be received from a user device with respect to which the second application can be determined to be installed, such as in a manner described herein. In certain implementations, various aspects of block 306 can be performed by playable application generation engine 130 and/or server machine 120, while in other implementations such aspects may be performed by one or more other elements and/or components, such as those described herein.

In one implementation, the user device may display the playable application in conjunction with a second application that is installed on the user device. The user device may receive user interaction of a user with the playable application. The user interaction may include engagement of the user with portions of the playable application (e.g., duration of time that the user spends at or interacts with each portion of the playable application, etc.). The user interaction may include performance of the user with portions of the playable application (e.g., score, level achieved, performance level, etc.).

In one implementation, the user device displaying the playable application in conjunction with the second application may include executing the playable application and the second application on the user device. The second application may be provided to the user device via an application distribution system 150 prior to executing the second application on the user device and the playable application is not provided to the user device via the application distribution system 150 prior to executing the playable application on the user device.

In one implementation, the playable application may display a prompt and the processing logic may receive an acceptance of the prompt. The processing logic may provide the first application to the user device via an application distribution system in response to receiving the acceptance, where the first application is to be configured based on the user interaction. For example, if the user interaction includes the user being engaged with portions of the playable application, the first application may be configured based on that engagement (e.g., displaying portions of the first application similar to the portions of the playable application with which the user was engaged). In another example, the user interaction includes the user having a performance with the playable application, the first application may be configured based on the performance (e.g., start the first application at the level where the user left off on the playable application, include the score from the playable application in the first application, adjust the level of difficulty of the first application due to performance on the playable application, etc.). In another example, the first application is configured based on the engagement and performance of the user on the playable application.

In one implementation, the first application may be installed on the user device prior to displaying the playable application on the user device. The processing logic may receive an acceptance of a prompt displayed on the playable application and, in response to receiving the acceptance, the processing logic may execute the first application on the user device based on the user interaction. For example, the first application may be configured to display available in-app purchases related to the user interaction with the playable application. In another example, the first application may be configured to display portions of the first application that are related to the user interaction with the playable application.

In one implementation, the playable application may be displayed in conjunction with the second application for a predetermined amount of interactions (e.g., a predetermined amount of moves, a predetermined amount of inputs, a predetermined amount of levels, etc.). In one implementation, the playable application may be displayed in conjunction with the second application for a predetermined amount of time. In another implementation, the playable application may be displayed based on a predetermined amount of interactions and a predetermined amount of time (e.g., until the sooner of five minutes or 100 moves).

The playable application may provide one or more prompts at intervals based on the user interaction. For example, if the user has high performance on the playable application, the playable application may display a prompt to download a more difficult application from the application distribution service 150 and if the user has a lower performance on the playable application, the playable application may display a prompt to download a less difficult application from the application distribution service 150. In another implementation, if the user is engaged with portions of the playable application, the playable application may display prompts to download an application from the application distribution service 150 related to the one or more portions of the playable application. In another implementation, as the predetermined amount of time or interactions that the playable application is to be displayed in conjunction with the second application nears expiration, prompts may be displayed more often. In another implementation, a prompt may display the amount of interactions or time that remains until the playable application will no longer be displayed in conjunction with the second application.

The user may interact with the second application prior to the displaying of the playable application. In one implementation, the processing logic may determine user interest in a topic of the second application and determine the first application is related to the topic. In response to determining the first application is related to the topic, the processing logic may generate the playable application based on the first application. In another implementation, the user device may determine second user interaction with the second application (e.g., engagement with portions of the second application, performance on the second application, etc.) and the displayable application may be displayed based on the second user interaction with the second application (e.g., the playable application may be configured at a level of difficulty based on the second user interaction, etc.)

In one implementation, the playable application has an appearance that is substantially similar to the first application. In another implementation, the playable application has an appearance that is different from the first application and the playable application includes a subset of the functionalities of the first application.

FIG. 3B depicts a flow diagram of aspects of a method 330 for receiving a playable application at a user device, in accordance with one implementation of the present disclosure.

At block 332, the processing logic receives a freestanding application via an application distribution system (e.g., application distribution service 150). Block 332 may include the processing logic transmitting a request for the freestanding application to the application distribution service 150, the processing logic receiving the freestanding application via the application distribution service 150, and the processing logic installing the freestanding application. Block 332 may include the processing logic configuring the freestanding application (e.g., adjust the difficulty level, apply user profile information, etc.). Block 332 may be in response to a user downloading an app (e.g., freestanding application) from an app store.

At block 334, the processing logic executes the freestanding application. Executing of the freestanding application may include running the freestanding application on the user device. Block 334 may be in response to user launching the app (e.g., the freestanding application that was downloaded from the app store).

At block 336, the processing logic receives a playable application not via the application distribution system 150. The processing logic may receive the playable application via the server machine 120 and/or playable application generation engine 130. In one implementation, the playable application is not freestanding (e.g., the playable application may need to be displayed and/or executed in conjunction with another application). Block 336 may include the app (e.g., freestanding application that is downloaded from the app store and launched) loading the playable application (e.g., in a background process). In one implementation, block 336 occurs before block 334.

At block 338, the processing logic displays the playable application in conjunction with the freestanding application. The playable application may be overlaid on the freestanding application. The playable application may be displayed at predetermined intervals (e.g., between levels of a game, etc.). Block 338 may include the app (e.g., freestanding application) displaying the playable application.

At block 340, the processing logic receives user interaction of a user with the playable application. The user interaction may include the user playing a game displayed via the playable application.

In one implementation, the playable application may be generated by processing a first application that includes a plurality of functionalities and the playable application may include a subset of the plurality of functionalities. The processing logic may display a prompt via the playable application, receive an acceptance of the prompt, and receive the first application via the application distribution system in response to receiving the acceptance.

In one implementation, the playable application may be displayed in multiple instances. For example, the playable application may be displayed between the first and second levels of the freestanding application and the playable application may be displayed between the third and fourth levels of the freestanding application. In another example, the playable application may be shown in conjunction with a freestanding application and at a later point in time the playable application may be shown in conjunction with the freestanding application or a different application. In one implementation, receiving the user interaction of the user with the playable application is in response to displaying the playable application in a first instance, where the processing logic is to display the playable application in a second instance subsequent to the first instance based on the user interaction. For example, if a user finishes levels one and two when interacting with the playable application in a first instance, the playable application may be displayed at level three when the playable application is displayed in a second instance. The user interaction in the first instance may be stored on the user device (e.g., via a cookie) or on the server machine 120.

Displaying of the playable application in conjunction with the freestanding application may be based on one or more of user information of the user (e.g., user demographics, profile information, user history, etc.), second user interaction with the freestanding application, location of the user device, or time of day.

FIG. 3C depicts a flow diagram of aspects of a method 360 for enabling application delivery, in accordance with one implementation of the present disclosure.

At block 362, the processing logic receives a first application including a plurality of functionalities.

At block 364, the processing logic processes the first application to generate a playable application including a subset of the plurality of functionalities. In certain implementations, various aspects of block 364 can be performed by playable application generation engine 130 and/or server machine 120, while in other implementations such aspects may be performed by one or more other elements and/or components, such as those described herein. The playable application includes an application configured for presentation in conjunction with a second application. The playable application may respond to a plurality of user inputs in a substantially similar manner as the first application responds to the plurality of user inputs.

At block 366, the processing logic receives one or more inputs with respect to the second application from a user device with respect to which the second application can be determined to be installed. For example, the one or more inputs may include a request for the second application (e.g., a download request) transmitted by the user device to the application distribution service 150.

At block 368, the processing logic provides the playable application to the user device in response to receipt of the one or more inputs. For example, the processing logic may provide the playable application to the user device in response to determining that the user device transmitted a download request for the second application. The user device may display the playable application in conjunction with the second application. The user device may receive user interaction (e.g., engagement with one or more portions of the playable application, performance of the user on the playable application, etc.) of a user with the playable application.

It should be noted that though much of the forgoing description is directed to implementations pertaining to application delivery in promotional contexts, the scope of the present disclosure is not so limited. Accordingly, it should be understood that the technologies described herein can be similarly implemented in any number of other settings and/or contexts. In doing so, a playable application can be generated (e.g., converted from a freestanding application) and delivered in a manner than enables users to interact with the playable application (e.g., instantly sample actual features of the freestanding application) and then take various actions based on their experience(s). It should also be understood that further technical advantages, solutions, and/or improvements (beyond those described and/or referenced herein) may also be enabled as a result of such implementations.

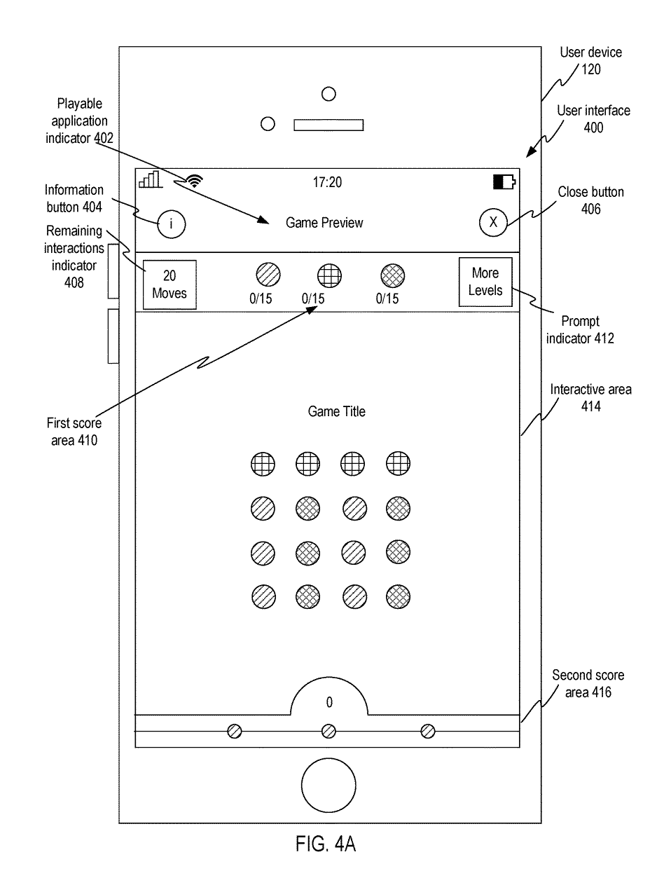

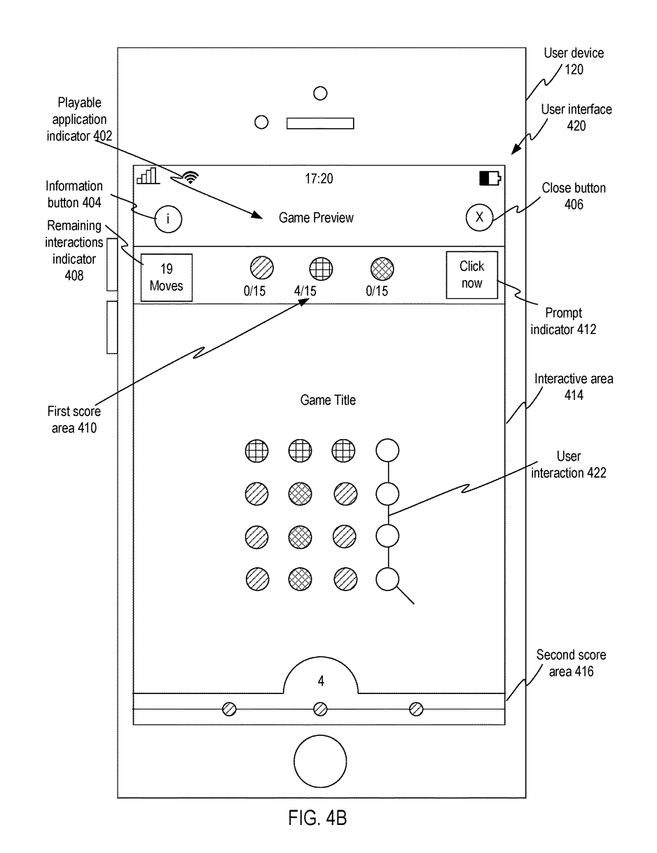

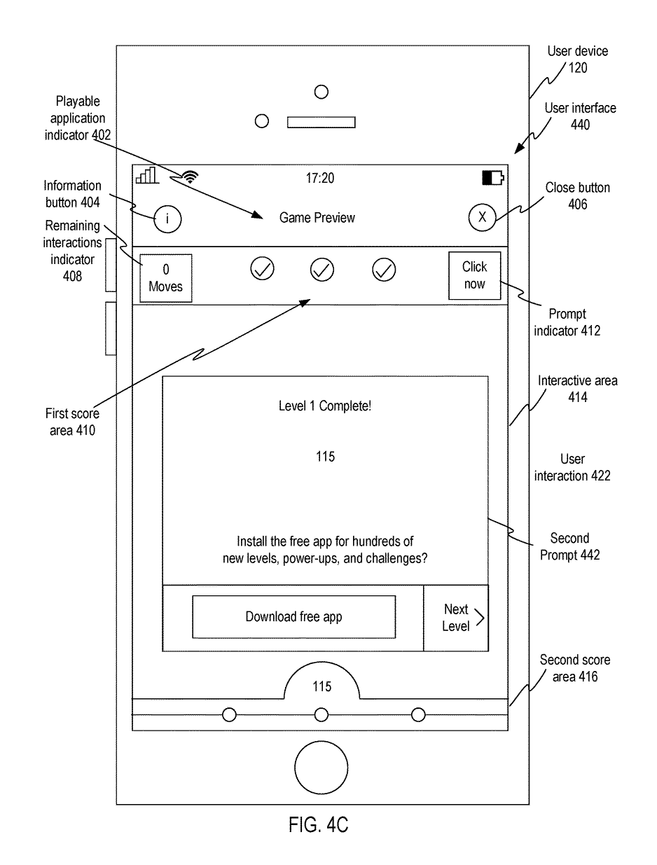

By way of illustration, FIG. 4A is an example user interface 400 of an exemplary playable application (here, a game of connecting objects), in accordance with aspects and implementations of the present disclosure. A user device 102 may display the user interface 400. The user interface 400 may display one or more of a playable application indicator 402, an information button 404, a close button 406, a remaining interactions indicator 408, a first score area 410, a prompt indicator 412, an interactive area 414, and/or a second score area 416.

The playable application indicator 402 (e.g., the text “Game Preview”) may indicate to the user that the playable application is different from the freestanding application the user was interacting with prior to the playable application being displayed. Upon user interaction with the information button 404, the playable application may display information regarding the playable application (e.g., title, developer, price, details, reviews, related applications, etc.). Upon user interaction with the close button 406, the playable application may not be displayed and the freestanding application the user was interacting with prior to the playable application being displayed may be displayed. The remaining interactions indicator 408 may display one or more of the remaining time, remaining interactions (e.g., 20 moves), remaining levels, etc. that remain before the playable application will no longer be displayed. The first score area 410 may display one or more scores (e.g., 0/15, 0/15, 0/15) based on user interaction with the playable application. The prompt indicator 412 may display one or more prompts at one or more intervals. For example, the prompt indicator 412 may display “more levels” in one interval and “click now” at another interval. The interactive area 414 may display information regarding the playable application (e.g., game title, etc.) and may receive user interaction. The second score area 416 may display an overall score (e.g., “0”) and other information.

As described, the playable application can be generated based on a ‘full featured’ version of the application (e.g., as may be provided via an ‘app store’). As shown in FIG. 4A, a user can interact with the playable application via the user device 102, e.g., in order to play the game. It should be understood that the playable application may be presented at the user device in a promotional or other context. For example, as shown in FIG. 4A, the depicted ‘Game Preview’ may be presented and/or provided at the user device 102 in conjunction with another application (which is executing on the user device 102). For example, while the user device 102 is executing a first game (or application), in between levels of such a game (or at other intervals), a playable application (e.g., the game preview) can be provided and/or presented at the user device 102 (e.g., in lieu of the presentation of some form of static advertisement or other promotional content).

FIG. 4B is an example user interface 420 of user interaction 422 with an exemplary playable application, in accordance with aspects and implementations of the present disclosure. User interface 420 displays user interaction 422 (e.g., connecting of the objects) with the interactive area 414 of the playable application. In response to the user interaction 422, the remaining interactions indicator 408 may be updated (e.g., display “19 moves”), the first score area 410 may be updated (e.g., 0/15, 4/15, 0/15), the interactive area 414 may be updated, and the second score area 416 may be updated (e.g., total score of “4”).

The user can interact with the playable application (here, a game of connecting objects), e.g., for a certain period of time or any other such interval or milestone (e.g., a certain number of ‘moves’ or interactions, through a certain level, etc.), such as is shown in the remaining interactions indicator 408 of FIG. 4B.

FIG. 4C is an example user interface 440 of a prompt to take further action, in accordance with aspects and implementations of the present disclosure. User interface may display a second prompt 442. The second prompt 442 may be displayed in response to the remaining interactions expiring. The remaining interactions indicator 408 may be updated (e.g., display “0 moves”), the first score area may be updated (e.g., check mark in each of the scores), the second score area 416 may be updated (e.g., total score of 115, next move is not displayed), and the interactive area 414 may display a second prompt 442. The second prompt 442 may display information (e.g., completion level (“Level 1 Complete!”), total score (“115”), an invitation to download the application from which the playable application is converted (e.g., “Install the free app for hundreds of new levels, power-ups, and challenges?”), etc.). The second prompt 442 may display a button to download the application from which the playable application is converted (e.g., “Download free app”). The second prompt 442 may display a button to continue to the next level of the playable application (e.g., “next level”).

At various intervals the user can be prompted (via the user device) to take further action, e.g., to download the ‘full’ application (e.g., via an application distribution service) and/or to proceed in further interacting with the converted application (e.g., to proceed to the next level), such as is depicted in the second prompt 442 of FIG. 4B.

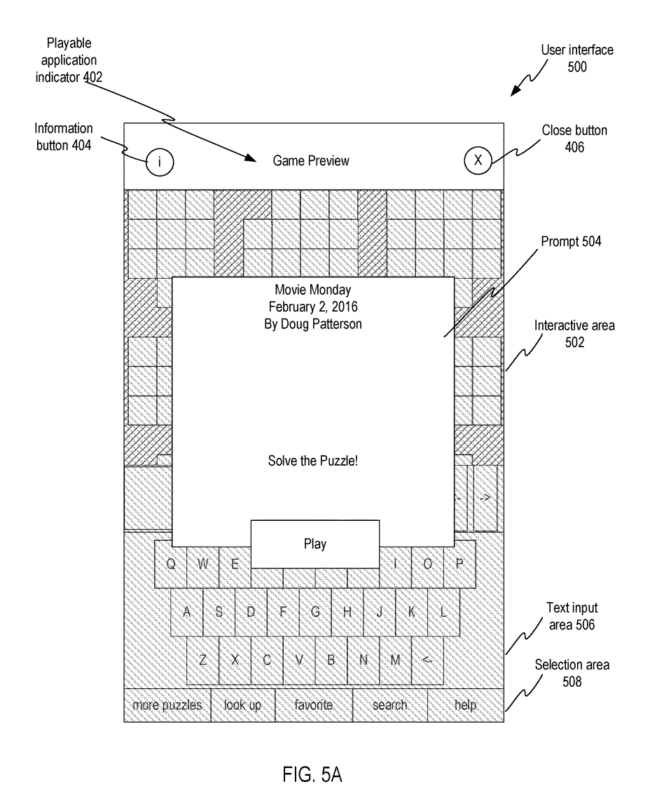

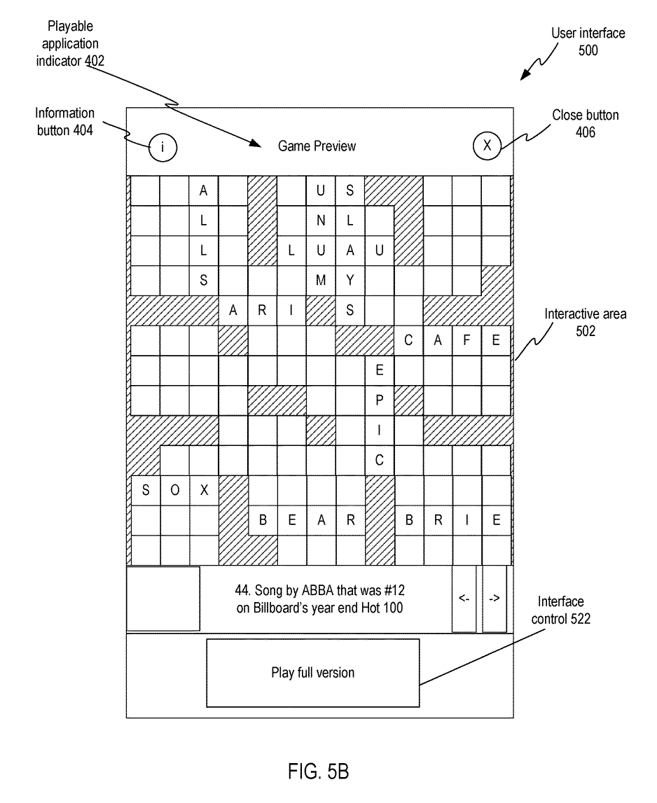

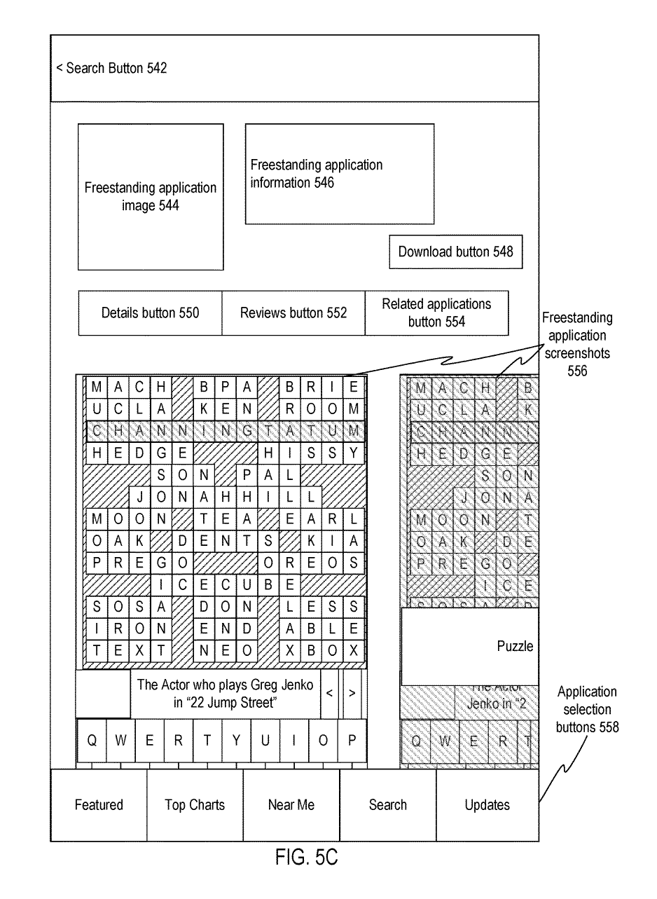

By way of further illustration, FIG. 5A is an example user interface 500 for presenting a playable application, in accordance with aspects and implementations of the present disclosure. User interface 500 may include a playable application indicator 402, an information button 404, and a close button 406. User interface 500 may include an interactive area 502, a prompt 504, a text input area 506, and a selection area 508.

Interactive area 502 (e.g., a game, a crossword puzzle, etc.) and text input area 506 (e.g., a QWERTY keyboard, etc.) may be overlaid with a prompt 504. A user may select the prompt (e.g., “play”) to interact with the interactive area 502. The selection area 508 may display one or more buttons the user can select (e.g., “more puzzles” for additional puzzles, “look up” to look up an answer or a hint, “favorite” for a list of favorite puzzles or games, “search” to search for puzzles or games, “help” for help with the playable application, etc.). In one implementation, the interactive area 502, text input area 506, and selection area 508 may not be selectable when the prompt 504 is being displayed (e.g., the interactive area 502, text input area 506, and selection area 508 may be shaded, blurred, or otherwise obscured).

As shown in FIG. 5A, a playable application (here, a crossword puzzle application/game) can be presented via user interface 500. As shown in FIG. 5A, the user interface 500 may display a prompt 504 presenting the option to the user to proceed in interacting with (e.g., playing) the playable application, e.g., for a defined period of time (e.g., 10 seconds) (e.g., by clicking/tapping the ‘Play’ button, as shown in FIG. 5A). If the user does not elect to proceed, they may return to the original application they were interacting with, the webpage they were viewing, etc. (e.g., after 10 seconds of displaying the prompt). In a scenario in which the user elects to interact with the playable application (here, a crossword puzzle application), during the time that the user interacts with the playable application, various prompts (e.g., buttons) or any other such user interface elements can be presented which, when activated and/or interacted with, can enable the user to initiate and/or obtain the ‘full’ version of the playable application.

FIG. 5B is an example user interface 520 displaying an interface control 522 (e.g., prompt) to obtain a full version of the application, in accordance with aspects and implementations of the present disclosure. For example, as shown in FIG. 5B, an interface control 522 (e.g., a prompt, a ‘Play Full Version’ button, and/or any other such user interface control) can be displayed periodically and/or continuously while the converted application is being presented.

FIG. 5C is an example user interface 540 for obtaining a full version of the application, in accordance with aspects and implementations of the present disclosure. The full version of the playable application may not be downloaded on the user device 102. User interface 540 of FIG. 5C may be displayed after selecting interface control 522 of FIG. 5B or prompt 504 of FIG. 5A. A corresponding user interface for obtaining a full version of the application may be displayed after selecting prompt indicator 412 or second prompt 442 of FIG. 4C. Upon selecting such a control (e.g., interface control 522, prompt 504, prompt indicator 412, second prompt 442, etc.), the user device 102 can initiate the process of obtaining the ‘full’ version of the application (e.g., the application based upon which the converted application was generated), such as by navigating to a user interface 540 of an ‘app store’ from which the user device 102 can download the ‘full’ version of the application, such as is depicted in FIG. 5C.

User interface 540 displays one or more of a search button 542, a freestanding application image 544, freestanding application information 546, a download button 548, details button 550, reviews button 552, related applications button 554, freestanding application screenshots 556, or application selection buttons 558. Upon selection of the search button 542, a search box, search options, or search results may be displayed. The freestanding application image 544 may display an image that represents the freestanding application or the developer of the freestanding application. The freestanding application information 546 may include information such as one or more of the title of the freestanding application, the developer of the freestanding application, cost of the freestanding application, whether the freestanding application offers in-app purchases, etc. Upon selection of the download button 548, the user device 102 may transmit a request for the freestanding application to the application distribution service 150, the application distribution service 150 may transmit the freestanding application to the user device 102, and the user device 102 may install the freestanding application. Upon selection of the details button 550, the user interface 540 may display details of the freestanding application. Upon selection of the reviews button 552, the user interface 540 may display reviews of the freestanding application. Upon selection of the related applications button 554, the user interface 540 may display applications that are related to the freestanding application displayed in user interface 540. The freestanding application screenshots 556 may display screenshots of the freestanding application. Upon selection of one of the application selection buttons 558, the user interface 540 may display featured applications (e.g., featured control), most popular applications by category (e.g., top charts), applications related to locations near the user device 102 (e.g., near me), a search box (e.g., search), updates to applications on the user device 102 (e.g., updates).

It should be understood that by virtue of the fact that the playable application is presented in a particular context (e.g., in a promotional context, such as an overlay to a webpage, in between levels of another game that is executing on the device, etc.) various aspects of the interactions the user has with the playable application can be tracked. For example, whether or not the user ultimately downloaded the ‘full’ application, the interval/time during the user's interaction with the playable application that the user initiated a request, download, etc., of the full application, etc., can be tracked. Data pertaining to such interactions can be provided to the developer and various suggestions, optimizations (e.g., identifying points or features of the application where the user is more/less engaged), etc., can be generated and provided as a result.

In certain implementations, the manner in which the user is prompted to take various actions can dynamically change, such as based on the manner in which the user is interacting with the playable application. For example, the manner in which the user interacts with the playable application, different buttons/options may be presented to them (e.g., the ‘download free app’ and/or ‘next level’ buttons, as shown in FIG. 4C, the ‘play full version’ button (interface control 522) as shown in FIG. 5B, etc.), and such buttons/options may be presented in different ways (e.g., at different intervals). By way of illustration, if a user can be determined to be highly engaged with the playable application, an option to install the ‘full’ application may be provided sooner. By way of further illustration, based on the manner in which the user is interacting with the playable application (e.g., their achievement level in a game), the user can be prompted to take various actions (e.g., install) in regards to various other applications (e.g., games). For example, if a user can be determined to be struggling to with the playable application, a game that may be easier can be suggested. Alternatively, if the user can be determined to be playing the playable game successfully, a more challenging game can be suggested.

Additionally, in certain implementations various aspects of the user's achievement within the playable application can be accounted for when the ‘full’ version of the application is subsequently requested/installed. For example, if the user has already completed the first two levels of a game within the playable application, when installing the ‘full’ application, such ‘full’ application can be configured to begin on the next (e.g., third) level. By way of further example, based on a determination that the user did not exhibit a high skill level when playing the playable game, when installing the ‘full’ version of the game, the installed version can be configured on a relatively ‘easier’ setting.

Moreover, in certain implementations the manner in which a user is prompted to initiate a playable application can be adjusted in relation to the manner in which such a user can be determined to interact with a previously installed application, a webpage, etc. For example, as described herein, a prompt to initiate a playable application can be provided while a user device is executing another application (e.g., in a promotional context/capacity, such as in between levels of a game, as an overlay to a webpage as presented within a web browser, etc.), and such a prompt can be configured/adjusted based on the application, site, and/or other context. For example, if user can be determined to be performing well on a certain type/category of question (e.g., sports-related questions) in a general trivia game, converted version of another application that pertains to such a category (e.g., a sports trivia game) can be generated and/or provided, such as in a manner described herein. In doing so, the user can be provided with the opportunity to sample another application that can be determined to be likely to be of interest to them, based on the user's performance, etc., within a first application.

Additionally, in certain implementations the described technologies can be employed with respect to prompting a user during one application/within a certain context to utilize another application (e.g., an application already installed on the same user device) in a particular manner. For example, if a user is reading an article about sports within a first application, a prompt can be provided within the first application inviting the user to utilize a second application (which is already installed on the user device) in a certain manner, e.g., to launch the ‘sports’ category/section of a general trivia game. In doing so, the user can be prompted to engage with aspects, features, sections, etc., of other applications that are already installed on their device at a time/within a context that the user can be determined to be likely to be interested in such functionality.

FIG. 6 depicts a block diagram of an illustrative computer system operating in accordance with aspects and implementations of the present disclosure.

FIG. 6 depicts an illustrative computer system within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server machine in client-server network environment. The machine may be a personal computer (PC), a mobile or tablet computer, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing system (processor) 602 (e.g., processing device), a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a data storage device 616, which communicate with each other via a bus 608.

Processor 602 represents one or more processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like. The processor 602 is configured to execute instructions 626 for performing the operations and steps discussed herein.

The computer system 600 may further include a network interface device 622. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 616 may include a computer-readable medium 624 on which is stored one or more sets of instructions 626 which may embody any one or more of the methodologies or functions described herein. Instructions 626 may also reside, completely or at least partially, within the main memory 604 and/or within the processor 602 during execution thereof by the computer system 600, the main memory 604 and the processor 602 also constituting computer-readable media. Instructions 626 may further be transmitted or received over a network via the network interface device 622.

While the computer-readable storage medium 624 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” (e.g., non-transitory computer readable medium) shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing,” “receiving,” “providing,” “displaying,” “executing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. In certain implementations, this apparatus may be specially constructed for the required purposes. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It should be understood that the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
receiving a first application comprising a plurality of functionalities;
processing the first application to generate a playable application comprising a subset of the plurality of functionalities; and
providing, by a processing device, the playable application to a user device, wherein the user device is to display the playable application in conjunction with a second application that is installed on the user device, and the user device is to receive user interaction of a user with the playable application.

2. The method of claim 1, wherein:
the user device is to display the playable application in conjunction with the second application comprises executing the playable application and the second application on the user device;
the second application is provided to the user device via an application distribution system prior to executing the second application on the user device; and
the playable application is not provided to the user device via the application distribution system prior to executing the playable application on the user device.

3. The method of claim 1 further comprising:
receiving an acceptance of a prompt displayed on the playable application; and
providing the first application to the user device via an application distribution system in response to receiving the acceptance, wherein the first application is to be configured based on the user interaction.

4. The method of claim 1, wherein the first application is installed on the user device prior to displaying the playable application on the user device, the method further comprising:
receiving an acceptance of a prompt displayed on the playable application; and
in response to receiving the acceptance, executing the first application on the user device based on the user interaction.

5. The method of claim 1, wherein the playable application is displayed in conjunction with the second application for a predetermined amount of interactions.

6. The method of claim 1, wherein the playable application is to provide one or more prompts at intervals based on the user interaction.

7. The method of claim 1, wherein the providing of the playable application comprises determining user interest in a topic of the second application and determining the first application is related to the topic.

8. The method of claim 1, wherein the user device is to display the playable application based on second user interaction with the second application.

9. A system comprising:
a memory; and
a processing device, operatively coupled to the memory, to:
receive a freestanding application via an application distribution system;
execute the freestanding application;
receive a playable application, wherein the playable application is not freestanding and is not received via the application distribution system;
display the playable application in conjunction with the freestanding application; and
receive user interaction of a user with the playable application.

10. The system of claim 9, wherein:
the playable application is generated by processing a first application that comprises a plurality of functionalities;
the playable application comprises a subset of the plurality of functionalities; and
the processing device is further to:
display a prompt via the playable application;
receive an acceptance of the prompt; and
receive the first application via the application distribution system in response to receiving the acceptance.

11. The system of claim 9, wherein receiving the freestanding application comprises transmitting a request for the freestanding application to the application distribution system, receiving the freestanding application via the application distribution system, and installing the freestanding application.

12. The system of claim 9, wherein displaying the playable application in conjunction with the freestanding application comprises displaying the playable application as an overlay on the freestanding application.

13. The system of claim 9, wherein receiving the user interaction of the user with the playable application is in response to displaying the playable application in a first instance, wherein the processing device is to display the playable application in a second instance subsequent to the first instance based on the user interaction.

14. The system of claim 9, wherein displaying the playable application in conjunction with the freestanding application is based on user information of the user.

15. The system of claim 9, wherein displaying the playable application in conjunction with the freestanding application is based on second user interaction with the freestanding application.

16. They system of claim 9, wherein displaying the playable application in conjunction with the freestanding application is based on location of the processing device and time of day.

17. A non-transitory computer readable medium having instructions stored thereon that, when executed by a processing device, cause the processing device to:
receive a first application comprising a plurality of functionalities;
process the first application to generate a playable application comprising a subset of the plurality of functionalities, the playable application comprising an application configured for presentation in conjunction with a second application;
receive one or more inputs with respect to the second application from a user device with respect to which the second application can be determined to be installed; and
provide the playable application to the user device in response to receipt of the one or more inputs, wherein the user device is to display the playable application in conjunction with the second application and the user device is to receive user interaction of a user with the playable application.

18. The non-transitory computer readable medium of claim 17, wherein the playable application is to respond to a plurality of user inputs in a substantially similar manner as the first application responds to the plurality of user inputs.

19. The non-transitory computer readable medium of claim 17, wherein the playable application is displayed in conjunction with the second application for a predetermined amount of time.

20. The non-transitory computer readable medium of claim 17, wherein the user interaction comprises engagement of the user with one or more portions of the playable application.
